(19) United States
(12) Patent Application Publication
(10) Pub. No.: US 2013/0166774 A1
(43) Pub. Date: Jun. 27, 2013

(54) DYNAMIC NETWORK PROVISIONING SYSTEMS AND METHODS

(71) Applicants: PARAG PRUTHI, Princeton, NJ (US); Ashutosh Dutta, Bridgewater, NJ (US); Christopher Mac-Stoker, Brooklyn, NY (US)

(72) Inventors: PARAG PRUTHI, Princeton, NJ (US); Ashutosh Dutta, Bridgewater, NJ (US); Christopher Mac-Stoker, Brooklyn, NY (US)

(73) Assignee: NIKSUN, Inc., Princeton, NJ (US)

(21) Appl. No.: 13/614,230

(22) Filed: Sep. 13, 2012

Related U.S. Application Data
(60) Provisional application No. 61/534,213, filed on Sep. 13, 2011.
(60) Provisional application No. 61/534,221, filed on Sep. 13, 2011.
(60) Provisional application No. 61/541,668, filed on Sep. 30, 2011.
(60) Provisional application No. 61/541,733, filed on Sep. 30, 2011.

(51) Int. Cl. H04L 12/56

(52) U.S. Cl. CPC H04L 45/70
USPC 709/240; 709/242

(57) ABSTRACT

Methods and systems for dynamically provisioning a network are disclosed. A network may be dynamically provisioned by detecting network congestion due to data on the network, identifying a transmission from a source computer to a destination computer for distinct routing based on at least one packet of the transmission, directing at least one other packet of the identified transmission to be marked for distinct routing, and instructing a router to distinctively route the other marked packets in response to the detection of network congestion. A controller and a monitoring device may be used to implement dynamic network provisioning.

### CROSS REFERENCE TO RELATED APPLICATIONS

This application claims priority to U.S. Provisional Application Nos. 61/534,213 and 61/534,221 filed on Sep. 13, 2011 and to U.S. Provisional Application Nos. 61/541,668 and 61/541,733 filed on Sep. 30, 2011, all of which are entitled Network Monitoring Solutions and are incorporated fully herein by reference.

### BACKGROUND OF THE INVENTION

A computer network is a collection of computers and other hardware components interconnected by communication channels that enable the computers to communicate with one another. The other hardware components include routers that route communications from source computers to destination computers over the communication channels. During transmission the communications are broken into smaller portions of data called packets. The routers route the packets over the communication channels.

Network congestion may occurs when a router is carrying so much data that its quality of service deteriorates, which may result in delay and/or packet loss. The shift to more robust computer systems and applications will further tax existing computer networks. Thus, there is an ever present need for systems and methods of handling network congestion.

### SUMMARY OF THE INVENTION

The present invention is embodied in methods and systems for dynamically provisioning a network. The network may be dynamically provisioned by detecting network congestion due to data on the network, identifying a transmission from a source computer to a destination computer for distinct routing based on at least one packet of the transmission, directing at least one other packet of the identified transmission to be marked for distinct routing, and instructing a router to distinctively route the other marked packets in response to the detection of network congestion. A controller and a monitoring device may be used to implement dynamic network provisioning.

### BRIEF DESCRIPTION OF THE DRAWINGS

FIG. 1 is a block diagram of an exemplary environment for dynamic network provisioning in accordance with aspects of the present invention;

FIG. 2 is a flow chart of exemplary steps for dynamic network provisioning in accordance with aspects of the present invention;

FIG. 3 is an illustration depicting a network for use in describing a scenario in accordance with aspects of the present invention;

FIG. 4 is a block diagram depicting a system architecture for use in describing aspects of the present invention; and

FIG. 5 is a block diagram depicting an enhanced data interface (EDI) architecture for use in describing automatic configuration of a router from a controller in accordance with aspects of the present invention.

### DETAILED DESCRIPTION OF THE INVENTION

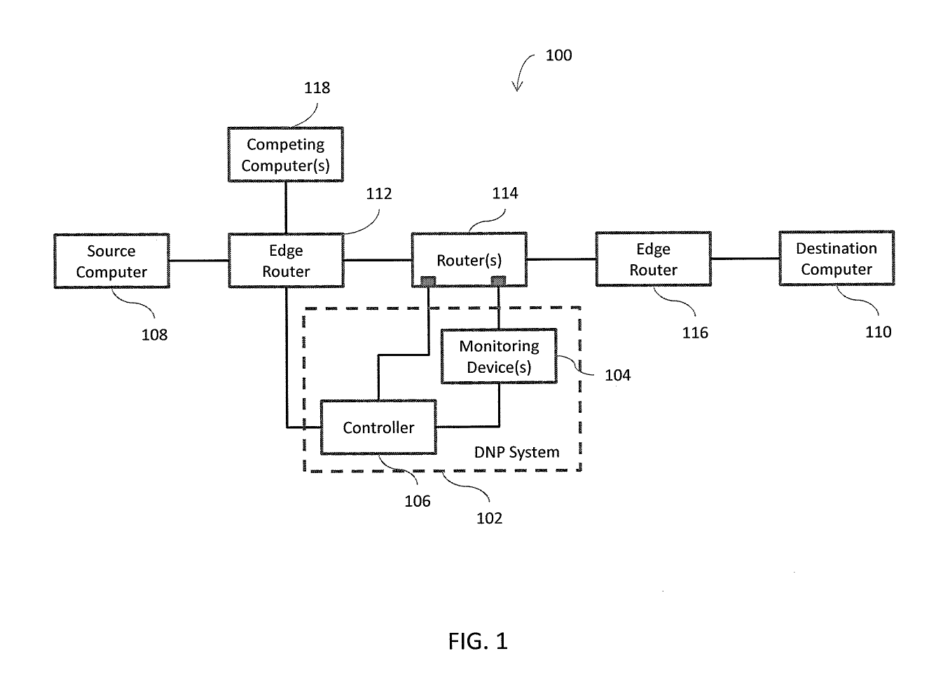

FIG. 1 depicts an exemplary environment 100 in which dynamic network provisioning in accordance with aspects for the present invention may be employed. In one embodiment, a dynamic network provisioning (DNP) system 102 is used to implement dynamic network provisioning. The various components within the exemplary environment may be coupled to one another via communication channels to form one or more communications networks (e.g., the Internet, internal networks, external networks and/or subnetworks). Each component may have an Internet protocol (IP) address that can be used to send transmissions to that component. Transmissions may include communications that are being relayed through the network(s) and instructions for configuring components within the network.

The illustrated system 102 includes one or more monitoring devices 104 and a controller 106 coupled to the monitoring devices 104. The monitoring devices 104 may be coupled to various locations with the network to monitor and store data packets passing through those locations. A suitable device for use as the monitoring devices 104 is a NetDetector available from NIKSUN Incorporated of Princeton, N.J. A suitable controller is a Windows based computer (e.g., configured with Windows XP available from Microsoft Corporation of Redmond, Wash.).

The network enables communication between computing devices. For example, a source computer 108 may transmit a data communication to a destination computer 110 via the network. The communication from the source computer 108 competes for computer resources (e.g., bandwidth) with competing computers 118 on the network. The term source computer 108 is used to refer to a computer at which a communication originates and the term destination computer 110 is used to refer to a computer to which the communication is addressed. It will be understood by one of skill in the art that the terms source and destination are merely used to facilitate description and that the source computer 108 could be the destination for a communication origination elsewhere and being sent to the source computer.

Source computer 108, destination computer 110 and competing computers 118 may be essentially any computing devices capable of communication with other devices. For example, source computer 108 may be a server and destination computer may be a home computer. Alternatively, source computer could be a first portable consumer electronic device and destination computer could be a second portable consumer electronic device where the first portable consumer electronic device is streaming video to the second portable consumer electronic device. Suitable computers for use with the present invention will be understood by one of skill in the art from the description herein.

Routers within the environment 100 relay communications from source computers such as source computer 108 to destination computers such as destination computer 110. The routers may include a first edge router 112, a second edge router 116, and one or more intermediate routers 114. In one embodiment, at least one of the routers 112/114/116 is configurable to mark communication packets for distinct treatment and at least one other router 112/114/116 is configurable to distinctively treat communication packets that are marked for distinct treatment.

In one embodiment, distinct treatment may involve marking the packets of an identified transmission for preferred treatment, e.g., a relatively high priority. In another embodiment, distinct treatment may involve marking the packets of an identified transmission for non-preferred treatment, e.g., a relatively low priority. There may be one or more levels of marking associated with these treatment options. In yet another embodiment, distinct treatment may involve marking packets of some transmissions for preferred treatment and packets of other transmissions for non-preferred treatment. Other distinct treatment options will be understood by one of skill in the art from the description herein.

The routers may be conventional routers capable of marking communication packets and/or distinctively treating marked packets. In one embodiment, all routers are configured to both mark communication packets and distinctively treat marked communication packets. The routers may include conventional routers and other devices configured to direct/route data through a network. The routing may be performed in one or more layers of the OSI model such as the application layer, the physical layer, and/or the network layer. A suitable router is a Cisco EDI router available from Cisco Systems, Inc. of San Jose, Calif. Other suitable routers for use with the present invention will be understood by one of skill in the art from the description herein.

In use, the source computer 108 may address a transmission such as a streaming media transmission to the destination computer 110. The transmission originating from the source computer 108, which is comprised on packets, may enter the network (e.g., the Internet) via an edge router 112. The edge router 112 routes the transmission packets to the router(s) 114, which in turn route the transmission packets to the edge router 116 for delivery to the destination computer 110. As used herein, the term streaming media transmission refers to a transmission of data that is constantly received by and presented to an end-user while being delivered by a provider. Streaming media transmissions may include audio and/or video.

There may be network congestion due to transmissions from competing computers 118. For bandwidth sensitive communications/applications such as, for example, streaming media, voice over IP (VoIP), interactive, gaming applications, multicast/unicast applications, the network congestion may cause a deterioration in the data when presented at the destination computer 110, e.g., due to delay and or packet loss. Aspects of the present invention ameliorate this problem. As used herein, the term congestion may be used to refer to the status of the network in general (e.g., based on the volume of data on the network exceeding a determined capacity for the network) and/or to the status of one or more locations with the network such as at a router (e.g., based on the throughput of the router and a capacity associated with that router). Congestion may be determined for one or more layers of the OSI model such as the application layer, the physical layer, and/or the network layer.

Monitoring device(s) 104 within the network monitor data packets flowing through the network at one or more locations within the network, e.g., at router 114. The monitoring device(s) 104 may be used by the controller 106 to identify transmissions for distinct treatment (e.g., streaming media transmission) based on their data packets. The transmissions may be identified based on their port and/or their signature, e.g., through DAR (dynamic application recognition). When such transmissions are identified, the controller directs other packets of the transmission (e.g., packets that have not yet reached the monitoring location) to be marked. For example, the controller may instruct the edge router 112 to mark the transmission packets for streaming media transmission.

The monitoring devices 104 may also be used by the controller 106 to identify network congestion, e.g., at one of the routers. When network congestion is identified, the controller 106 instructs the routers that receive the marked packets of the communication, e.g., routers 114 and edge router 116, to distinctively treat the marked packets. Thereby improving the quality of service for those transmissions in the case of preferred distinctive marking. In the case on non-preferred distinctive marking, the quality of service for other transmissions may improve due to the non-preferred marking of a transmission.

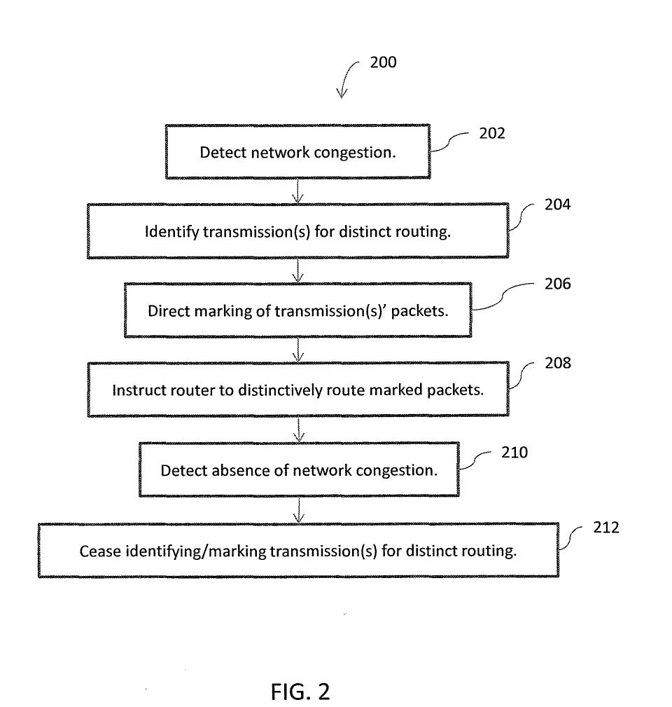

FIG. 2 depicts a flow chart 200 of steps for dynamically provisioning a network in accordance with one embodiment of the present invention. The steps are described with reference to the system 100 depicted in FIG. 1 to facilitation description. One of skill in the art will understand other systems/components that may be used to implement the steps of flow chart 200 from the description herein.

At block 202, network congestion due to data on the network is detected. The data passes through at least one router. In one embodiment, the controller 106 detects network congestion by retrieving data details gathered by the monitoring device(s) 104. Network congestion may be detected by associating a bit rate threshold with one of the at least one router, detecting a bit rate throughput at the one of the at least one router (e.g., the rate at which the router is handling packets), and detecting network congestion when the bit rate throughput exceeds the bit rate threshold.

At block 204, one or more transmissions within the data are identified for distinct routing. The transmissions may be identified based on the data packets within the transmission. The transmission may be from a source computer 108 to a destination computer 110. The monitoring devices 104 may gather information on transmissions on the network. In one embodiment, the controller 106 may periodically query the monitoring device to identify transmissions of a particular type. For example, if it is desirable to distinctively treat streaming media transmissions, monitoring device(s) 104 may be configured to identify and record streaming media packets. The controller can then identify streaming media transmissions by querying the monitoring device(s). In another embodiment, the monitoring devices 104 may be configured to generate alarms that are sent to the controller when certain conditions are met. For example, when a particular communication type is received from a particular subscriber. In this embodiment, the controller 106 identifies transmission for distinct routing based on alarms received from the monitoring devices 104.

In one embodiment, transmissions from the source computer 108 to the destination computer 110 are identified for distinct routing in response to the detection of network congestion. In another embodiment, transmissions are continuously identified regardless of whether there is network congestion.

At block 206, at least one other packet of the identified transmission is directed to be marked for distinct routing. In one embodiment, the controller 106 may direct a router such as an edge router 112 or other router 114 to mark the other packets associated with a transmission. In another embodiment, the controller may direct the source of the transmission (such as a portable consumer electronic device) to mark the packets. In one embodiment, packets are marked by setting the type of service field of an internet protocol header with EF (expedited forwarding). In accordance with this step, packets following the packets that have already been exposed to network congestion are marked in order to ameliorate the impact of network congestion on subsequent packets in the transmission through distinctive routing as described below.

At block 208, instructions are sent to at least one router instructing the router to distinctively route the marked packets. The controller 106 may instruct one or more routers such as edge router 112, router(s) 114, and/or edge router 116 to distinctively route marked packets. The controller 106 may configure the at least one router with priority queues so that the at least one other marked packet is distinctively treated. The instructions may configure the router(s) with priority queues by configuring the router(s) for differential service (diffserv). Once configured for differential service, a router will distinctively route packets marked for expedited forwarding over packets that are not marked.

At block 210, the absence of network congestion due to data on the network is detected. In one embodiment, the controller 106 detects the absence of network congestion by retrieving data details gathered by the monitoring device(s) 104. The absence of network congestion may be detected by associating a lower bit rate threshold with one of the at least one router, detecting the bit rate throughput at the one of the at least one router, and detecting the absence of network congestion when the bit rate throughput is lower than the bit rate threshold.

At block 212, the identifying and/or marking of transmissions for distinct routing is ceased. In one embodiment, the identification of transmissions ceases once network congestion has cleared. In another embodiment, the identification of transmissions continues, but the transmissions are no longer marked once the congestion clears. This enables transmissions to be more quickly marked in the future should network congestion be detected.

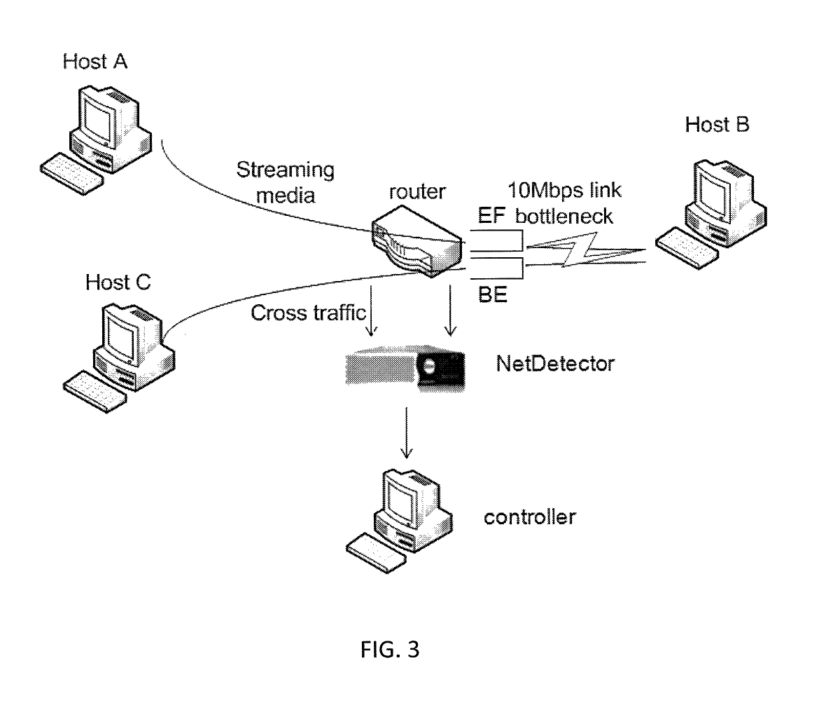

FIG. 3 depicts a network coupling computer devices (Host computers A, B, and C) for communication. A scenario in which aspects of the present invention may be used is now described with reference to FIG. 3. The aspects of the methods and systems of the present invention gather feedback about the network's condition and dynamically control the router(s) and assign priority to application data under network congestion.

In FIG. 3, the data of interest is the streaming media data being sent from source computer (Host A) to a destination computer (Host B). The streaming media may be real-time transport protocol (RTP) data including video and/or audio. It is assumed that the egress link (link between the router and the destination computer) connected to a destination subnet is the bottleneck of the network, which means that it will become congested first when the application and the cross traffic (e.g., data from other computers) compete for the limited bandwidth resources of the network.

To emulate network congestion, cross traffic is generated from another computer (Host C) to, for example, the same destination computer. A monitoring device such as a NetDetector can monitor both the data at the source computer's subnet and the destination computer's subnet using two separate recording interfaces. Alternatively, multiple monitoring devices may be used. The controller can query the monitoring device(s) periodically over an interval of time. When the controller detects the streaming media data of interest, it may automatically instruct the source computer to mark the differentiated services code point (DSCP) of the IP packet at the source host to expedited forwarding (EF) class.

The controller may also query the monitoring device(s) to get the application bit rate at the source computer's subnet. When the bit rate exceeds an upper threshold due to the cross traffic, the controller may automatically command the router to establish a differentiated service (diffserv) quality of service (QoS) with the streaming media data placed into a high priority queue, which may possess a minimum assured bandwidth, while the cross traffic data is put in a low priority queue, which may have best-effort forwarding and a maximum bandwidth usage, thus high drop probability. When the cross traffic data disappears (the application bit rate is lower than a lower threshold), the controller can command the router to clear the diffsery related configuration.

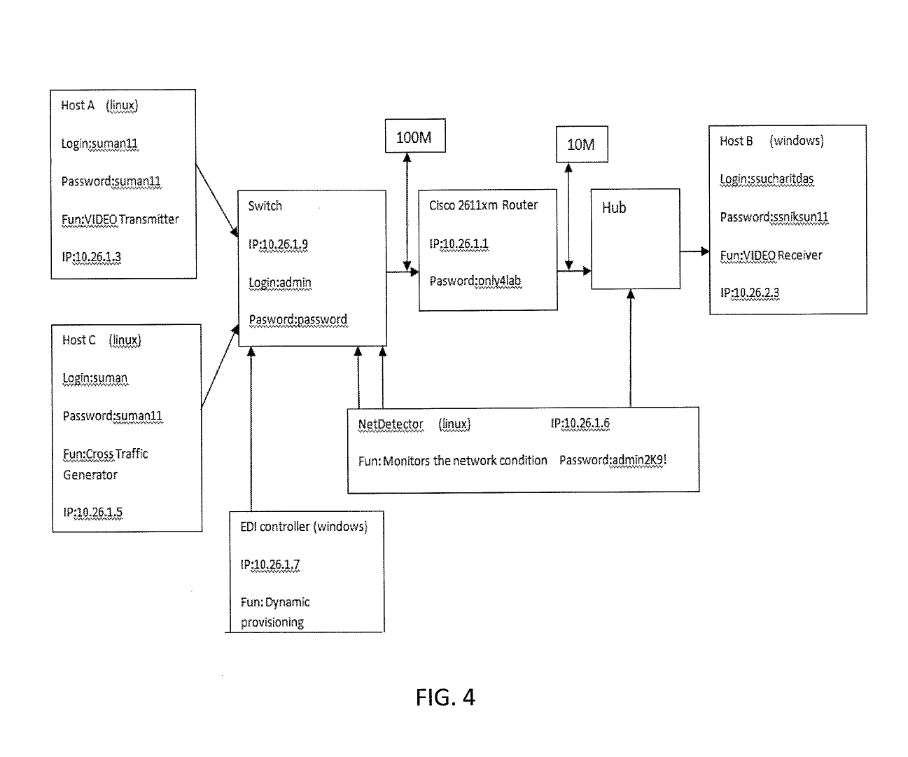

FIG. 4 depicts a system architecture for use in explaining techniques of implementing aspects of the present invention. Ideally, the controller, electronic data interchange (EDI) server and monitoring device (NetDetector) should be in a subnet other than the subnets of the source/destination so that control data associated with these devices is not congested. As there are only two fast Ethernet interfaces with the router 2611xm in the embodiment illustrated in FIG. 4, special deployment may be necessary to achieve this purpose. The destination subnet has a 10M Ethernet interface and the source subnet has a 100M fast Ethernet interface. Note that the destination subnet (with 10M Ethernet interface) will be congested before the source subnet (with 100M fast Ethernet interface), therefore it would be beneficial to have all the control data within the source subnet. As control data is generated by communication among controller, NetDetector, EDI server, router and application source host, all these units may be sitting at the source subnet to avoid congestion of control data.

Each component within FIG. 4 is now described.

Source subnet (IP address: 10.26.1.0): connected to the FastEthernet 0/0 of the router with 100M speed. Devices in the source subnet include Host A and Host C. Details regarding Host A and Host C are as follows:

Host A: streaming media server which delivers a unicast stream to the client (host B). Operating system (OS): linux, IP address: 10.26.1.3

Host C: source host to generate cross traffic. OS: linux, IP address: 10.26.1.5

NetDetector: Management port and one recording interface are connected to the source subnet, and another recording interface is connected to the destination subnet. IP address of the management port: 10.26.1.6

EDI server & controller: used to manage network devices and query NetDetector to get the data information as well as to invoke the configuration of the router and mark the data. OS: windows 7 (or windows XP), IP address: 10.26.1.7

All the devices are connected using a switch in the illustrated embodiment. The recording interface of the NetDetector is connected to a span port to sniff the bidirectional data from and to the fastEthernet 0/0 port of the router.

Router: device type: Cisco 2611xm (Cisco 2600 series); IDU version: 1.4, OS version: IOS 12.3(6e). It has two fastEthernet interfaces. FastEthernet 0/0 is set to speed of 100M while fastEthernet 0/1 is set to speed of 10M so that the link connected to fastEthernet 0/1 is the bottleneck of the illustrated network and will be congested first due to the cross traffic. FastEthernet 0/0: IP address: 10.26.1.1 (255.255.255.0); full duplex, 100M. FastEthernet 0/1: IP address: 10.26.2.1 (255.255.255.0): full duplex, 10M.

Destination subnet(IP address: 10.26.2.0): connected to the FastEthernet 0/1 of the router with (10M speed). This subnet includes Host B: application and cross traffic destination host. OS: linux, IP address: 10.26.2.3

Another recording interface of NetDetector along with the Host B is connected to the hub which connects the destination subnet to the fastEthernet 0/1 of the router.

The sub system details are now described, including automatic configuration of router through EDI server, query bit rate through URI API, delivering unicast media streaming from source to destination and generating cross traffic.

In one embodiment, the system is implemented in Java, a programming language available from Oracle or Redwood Shores, Calif. Exemplary Java programs that may be used are summarized in Table 1.

TABLE 1
Programs

| Package | class | comment |
|---|---|---|
| Netdetector | DynamicProvisioning | Main class, implements the |
| | | dynamic provisioning |
| | QueryNetDetector | Implements use of the URI API to |
| | | query NetDetector |
| | Mark_DSCP | Implements marking dscp at |
| | | application source host. |
| | | Additional jar package |
| | | “commons-net-1.0.0-dev.jar” |
| | | may be needed. |
| com.niksun.dynamicconfig | Config | Implements connecting to the |
| | | EDI server to edit configuration |
| | | of the router. Additional jar |
| | | package “netconfapi.jar” may be |
| | | needed. |
| | Command | Implements reading command |
| | | from a file and return a |
| | | command string |

The implementation of dynamic network provisioning in accordance with one aspect of the present invention is now described. For the main class “DynamicProvisioning”, one program argument and one VM argument are specified, which is the path of the file containing all the parameters and the path of the log 4j.properties file, respectively. “Log 4j.properties” file is used for the purpose of initializing log 4j for the cisco NETCONF API. The parameter file is in the format of XML and includes three groups of parameters related to NetDetector, application, and router respectively. The following table summarizes these parameters:

TABLE 2
Parameters

| | | |
|---|---|---|
| NetDetector | ipaddress | IP address of NetDetector |
| | username | User name for GUI of NetDetector |
| | password | Password for GUI of NetDetector |
| | recorder | Name of recorder at source subnet |
| | interface | Name of interface at source subnet |
| | interval | Time interval for controller to poll |
| | | NetDetector |
| | upperthreshold | Upper threshold for application bit rate |
| | lowerthreshold | Lower threshold for application bit rate |
| Application | srcip | IP address of application source host |
| | dstip | IP address of application destination |
| | | host |
| | dstport | Destination port number of application |
| | srcusername | User name of application source host |
| | srcpassword | Password of application source host |
| Router | ediserver | IP address/host name of EDI server |
| | ipaddress | IP address of router interface in the |
| | | same subnet as controller and EDI |
| | | server |
| | login | telnet user name of the router |
| | password | telnet password of the router |
| | enable | enable password of the router |
| | readcommunity | Name of read community for SNMP |
| | writecommunity | Name of write community for SNMP |
| | devicefamily | Device family of the router |
| | iduversion | IDU version of the router |
| | ovsersion | OS version of the router |
| | configfilepath | Path of the CLI to be used to configure |
| | | the router |
| | deletefilepath | Path of the CLI to be used to delete the |
| | | configuration of the router |

A dead loop is run in the main class to poll the NetDetector periodically. The time interval used for the polling can be specified in the parameters file. During every polling cycle, controller would first query NetDetector to check the information of application type and application bit rate. All these are measured at the ingress link of the router by the recorder at the source subnet. Niksun provides a URI API to query GUI information. The two URIs has the following form:

1. Check application type:

“/ngen/srvc/dashboardData?recorder=<recorder>&iface=<iface>&start Time=−2%20min&endTime=now&layer=Application&dataType=application& customDT=data Fields”

2. Get bit rate:

“/ngen/srvc/dashboardData?recorder=<recorder>&iface=<iface>&start Time=−2%20min&endTime=now&layer=Application&dataType=time,bitRate& customDT=dataFields&window=10”

In the second URI, time in the dataType filed as well as the window should be specified as bit rate is calculated in a time interval specified by the window. Here we use 10 s as the time interval. The response of the URI query will be stored in XML file “application.xml” and “bitRate.xml”, respectively. “checkApplication” method is used to parse the XML file “application.xml” and return a Boolean type flag to indicate whether there is the application type of interest in current data. Application type is included in the attribute “c1” of the element <item>. If the application is not using a common known port, the name of application returned is the destination port of the data. “1234” was used as the destination port of the RTP media streaming data for demonstration purposes. After parsing the XML file and doing the string match, the process of marking data is invoked once there contains applications of interest. A flag may be used to indicate whether the application data has been marked or not in order to guarantee the data is only marked once. Similarly, the marking policy may be deleted once the application data of interest disappears. Another method “getBitRate” is used to parse the XML file “bitRate.xml” to get the maximum bit rate during the polling cycle. The purpose of using maximum bit rate rather than average bit rate is to reduce the delay of the polling process. The bit rate information is included in the attribute c2 of a series of element <item>. Attribute c1 represents time and the time interval used to calculate bit rate is 10 seconds. The bit rate is first extracted as a string and then is converted to a float number. The obtained maximum bit rate will be compared with an upper threshold, if it is greater than the upper threshold, the process of configuring the router will be triggered. The configuration is only done once, and after that, the controller will continue to monitor the application bit rate. When the bit rate is less than the lower threshold, it will trigger the process to delete the configuration.

The querying of the monitoring device (e.g., NetDetector) in accordance with one aspect of the present invention is now described. NetDetector may be queried using a uniform resource identifier (URI) application programming interface (API) available from Niksun. A query process may contain three steps (i.e, steps i, and iii described below).

Step i. Session login—before a request is sent to NetDetector, authentication is done in order to perform a query. Authentication may be performed by sending a HTTP POST request to the following URI: https://<ApplianceIP or Host Name>/ngen/srvc/auth?action=login. In one embodiment, https and http are supported. This may be done by using the method “getHttpURLConnection” to open a URL connection. After that, post transaction data including the user name and the password may be sent through the URL connection. The data can be XML/HTML format as follows: <?xml version=\“1.0\”?><user><name>user</name><password>passwd</password></user>. Upon successful authentication, the system may return the following message: <ns2:status xmlsns2=“urn:status”>success</ns2:status>. During the login process, a new session cookie containing the unique sessionID information may be returned. This cookie is set for subsequent queries during the session and is removed after logout.

Step ii. Query data—this process is similar to that of session login except that the session cookie obtained from the login process should be used to open the HTTP URL connection. The query has the following general format: https://<ApplianceIPorHostName>/srv/dashboardData?recorder=<Recorder>&iface=<interface>&startTime=<StartTi me>&endTime=<EndTime>&layer=<Layer>&filter=<filter>&topN=<number>&customDT=<custom >&window=<WindowSize>&sortBy=<sort field>&dataType=<data type>. The response may be in an XML format and written in a XML file.

Step iii. Session logout—this process is also similar to the login process, except the following URL should be sent when opening a HTTP connection: https://<ApplianceIP or Host Name>/ngen/srvc/auth?action=logout. This releases all resources used by this session. Upon successful logout, the system may return: <ns2:status xmlsns2=″urn:status”>logout</ns2:status.

The automatic marking of streaming media in accordance with one aspect of the present invention is now described. The controller can connect to the application source host through telnet and then use command “iptables” to set the DSCP field of the outgoing data as 0x2e (EF class). The controller may login to the host with super user privilege to run the “iptables” command. Specific prompt patterns may need to be processed during the interaction. A command that may be used to set the DSCP field is as follows: iptables -A POSTROUTING -t mangle -p udp - m dp --dport <applicationdport>-d <applicationdstip>-j DSCP --set-dscp 0x2e. To delete the policy, the following command may be used: iptables -D POSTROUTING -t mangle -p udp -m udp --dport <applicationdport>-d <applicationdstip>-j DSCP -- set-dscp 0x2e

Currently, the IP address of the application source host and its credential, as well as the IP address of the destination host and destination port is known. In practice, the monitoring device may not know the credential of the host. In one embodiment, setting of the DSCP is done at the edge router according to the IP address of the application source host obtained by the monitoring device.

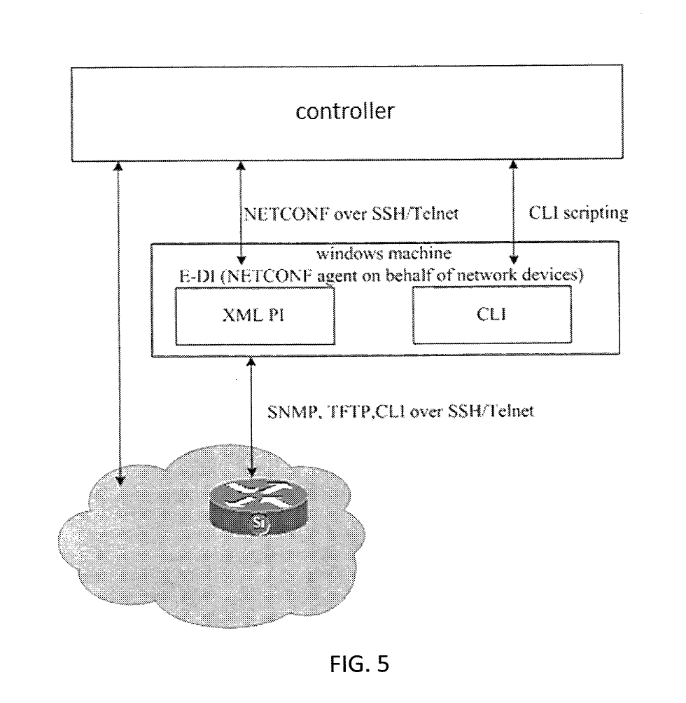

The router can be automatically configured from the controller, e.g., through Cisco EDI. This process will be described with reference to FIG. 5. EDI stands for enhanced device interface, and it can provide a comprehensive management interface for various devices, e.g., devices produced by Cisco Systems, Inc. of San Jose, Calif. Management applications handling multi-vendor devices expect a standard based programmatic interface. Cisco EDI provides an XML programmatic interface (PI) based on NETCONF protocol so that management applications can talk to EDI server through NETCONF over SSH/Telnet. Internally, an EDI server communicates with devices under management through various protocols such as SNMP, TFTP or CLI over SSH/Telnet. EDI server is run as a service on windows machine (currently only windows version of EDI is available). To facilitate use of the XML PI, Cisco EDI also provides a java SDK API to implement the NETCONF client. The Java API is used to automatically configure the device upon request. To finish a configuration, the basic procedures are as follows, which are implemented in the Java class config.java, provided that the IP address of EDI server, IP address of device to be configured, and credential set of the device to be configured for telnet session including user name, password, enable password, SNMP read and write community are specified. Java program “Config.java” under package “com.niksun.dynamicconfig” is the class used to implement the complete process to use EDI server to change the configuration of the router, which is summarized as follows:

1. Connect to EDI server

This step creates an XML session over telnet with port number 2323, and both user name and password to login EDI server is “admin”. Per request of NETCONF protocol, hello message will be sent from the NETCONF manager and received by EDI server (as a NETCONF agent) upon connection. If the controller and EDI server are located at the same windows machine, the IP address of the EDI server is the “localhost”.

2. Send a Cisco EDI specific message, associate-devices, as EDI server needs to be told which device to attach to the session. The associate-devices message uses the device IP address or name, and the device credentials. Upon connection to the EDI server, the first device to be attached is the server itself.

3. Create credential set for network devices. It includes name of credential set, user name, password, SNMP read and write community of devices and transport type for EDI server to talk to the devices. The name of the credential set is fixed to be “niksun” for exemplary purposes.

4. Assign credential set to the device to be configured and IP address of the device needs to be specified. After doing that, the state of the device changes from offline to managed status.

5. Converting CLI to be issued into XML format. The command can be in the form of CLI plain text format and XML format. However, the EDI server cannot handle the CLI plain text format very well especially when there is a block of CLI containing both global and sub mode commands. EDI provides an API to convert the CLI into XML format without having to connect to the network device. The user specifies the device family, IDU version and OS version to get a match of the XSD, which can be obtained by issuing the command in EDI “show server device-package”. The response of the NETCONF API is a complete XML file. Child elements may be extracted under element <DeviceConfiguration>, which is the exact XML format of the CLI. The CLI plain text is pre-written in a file and java class “Command.java” is provided to facilitate reading the command from the file into a string.

6. Associate device to be configured to EDI server. This is similar to step 2 except that the device IP address is that of the device to be managed. After that, the NETCONF session is equivalently to be done between NETCONF manager and device to be configured rather than the EDI server.

7. Send lockconfig message. This is a specified in NETCONF protocol and is done before editing the configuration so that other EDI users cannot edit the configuration.

8. Send editconfig message for the running configuration. This may be achieved by issuing the CLI command “copy tftp://<ediserver>/configuration_file running-config” via telnet session. Internally, the EDI server can automatically get the information of device family, IDU version and IOS version after successfully getting the device under managed status. The configuration file is generated at the temporary directory after reading the commands to be issued.

9. Send copyconfig message to copy running-config to the startup-config.

10. Unlock the running-config.

11. Disconnect the XML session.

Note: when issuing the CLI command “copy tftp://<ediserver>/configuration_file running-config”, EDI internally will use java class NetworkInterface and its method getByName( )to get IP address of the EDI server. However, it only checks interfaces with name eth0 and eth1. It works well in windows XP, but cannot work in windows 7 because the real Ethernet interface in windows 7 will probably not use the name of either eth0 or eth1. To check the name of the real Ethernet interface, the method getNetworkInterfaces( ) in class NetworkInterface may be used. One solution is to crack the java class binary <installation directory>/edi/dist/server/lib/nemo.jar/ServerNetworkInterface.class. To minimize change to the class binary, WinRAR may be used to open the jar package nemo.jar and extract the corresponding class binary, and then use a Hex editor to locate and replace “eth0” or “eth1” using the name of the real Ethernet interface.

The delivery of streaming media in accordance with one aspect of the present invention is now described. A VLC media player works as both streaming media server and client. At the source host, the server can read a MPEG2 file from a local host and then send it out as a RTP unicast streaming in loop. At the server side, in the command line, start the streaming: vlc <path to the file>--sout “#rtp{dst=<unicast address/IP address of the client>,mux=ts,port=1234}.” At the client side, the received stream is displayed and at the same time is saved as a MPEG2 file. In the command line, receive and save the stream vlc -vvv rtp://<unicast address/IP address of the client>:1234 --sout “#duplicate{dst=display,dst=standard {access=file,mux=ts,dst=<save path of the file>}}”

The generation of cross traffic to demonstrate network congestion in accordance with one aspect of the present invention is now described. The cross traffic may be emulated using the traffic generating tool jperf. Jperf is the GUI version of iperf. Jperf may be installed at both source and destination host. UDP data may be used. The source host, which sends the UDP data, is the client and the destination host, which receives the UDP data, is the server. The server side setting are iperf -s - u -P 0 -i 1 -p 5001 -w 2.0M -f m. The client side settings are iperf -c <IP address of the server>-u -P 1 -i 1 -p 5001 w 2.0m -f m -b 10.0M -t 120 -T 1. The server and client may communicate through the default port 5001. The buffer size for both the server and client may be 2 Mbyte. In one embodiment, the sending speed of the UDP packets is 10 Mb/s and will last for 120 seconds. 10 Mb/s UDP cross traffic can produce an obvious congestion for the 10 Mb/s link and thus severe drop of the video quality. The server can provide statistics on bandwidth (throughput), loss rate, and time jitter.

The controller may obtain information from the monitoring device by polling the monitoring devices and/or through alarms generated by the monitoring device and sent to the controller. Polling may be implemented by: (1) the controller (e.g., EDI controller) polling the monitoring devices (e.g., NetDetector) periodically (e.g., every 20 seconds) to obtain information about the application types associated with packet data and the bit-rate at the interface (e.g., FastEthernet0/0); (2) when the controller receives the query response from the monitoring device and finds that the type is of interest, e.g., “rtp,” and the bit-rate is greater than the upper-threshold, the controller marks the application data and then performs router configuration, e.g., through Netconf process. When the bit-rate falls below the lower-threshold, the controller ceases to mark the application data and de-configures the router. This process may be implemented in the controller as a java program.

Alarms may be implemented (e.g., via Syslog and/or SNMP trap) by: (1) the controller waiting for the monitoring device (e.g., NetDetector) to send and alarm message; (2) when the monitoring device finds that at the recorder em1 (connected to FastEthernet0/0) bit-rate is greater than upper-threshold, it sends either a Syslog message or SNMP trap (depending on implementation) to the controller (e.g., EDI controller) and then the controller decodes the message, marks the application data and configures the router; (3) when the monitoring device finds that at the recorder em1 (connected to FastEthernet0/0) bit-rate is less than lower-threshold, it sends a different alarm message reconfigures the router for normal operation. This process may be implemented in the controller as a java program. The monitoring device may generate an alarm as soon as it detects an anomaly in the network. In one embodiment, the monitoring device waits for a period of time (e.g., 10 seconds) before it sends the alarm. In accordance with this embodiment, the alarm is sent if similar events occur during the period of time.

Alternatively, the controller may be implemented with the monitoring device (e.g., within NetDetector). In accordance with this embodiment, a separate controller (e.g., EDI controller) is not necessary. A shell script may be written in the monitoring device to check the bit-rate and then perform marking of application data and configuration of the router(s) depending on the condition, i.e., the bit-rate being greater than the upper-threshold. In another embodiment, the controller and/or the monitoring device may be implemented in a router and may instruct the router itself and/or another router.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A dynamic network provisioning method comprising:
detecting network congestion due to data on a network, the data passing through at least one router;
identifying within the data a transmission from a source computer to a destination computer for distinct routing based on at least one packet of the transmission;
directing at least one other packet of the identified transmission to be marked for distinct routing; and
instructing the at least one router to distinctly route the at least one other marked packet in response to the detection of network congestion.

2. The method of claim 1, wherein the identifying step comprises:
identifying the transmission from the source computer to the destination computer for distinct routing in response to the detection of network congestion.

3. The method of claim 1, wherein the identifying step comprises:
identifying a streaming media transmission as the transmission.

4. The method of claim 1, further comprising the steps of:
detecting the absence of network congestion; and
ceasing the identifying step in response to the detected absence of network congestion.

5. The method of claim 1, wherein the detecting step comprises:
associating a bit rate threshold with one of the at least one router;
detecting a bit rate throughput at the one of the at least one router; and
detecting network congestion when the bit rate throughput exceeds the bit rate threshold.

6. The method of claim 1, further comprising the steps of:
detecting the absence of network congestion; and
directing the marking of the identified transmission to cease.

7. The method of claim 6:
wherein the step of detecting network congestion comprises:
associating an upper bit rate threshold with one of the at least one router;
detecting a bit rate throughput at the one of the at least one router; and
detecting network congestion when the bit rate throughput exceeds the bit rate threshold; and
wherein the step of detecting the absence of network congestion comprises:
associating a lower bit rate threshold with one of the at least one router;
detecting the bit rate throughput at the one of the at least one router; and
detecting the absence of network congestion when the bit rate throughput is lower than the bit rate threshold.

8. The method of claim 1, wherein the transmission originates from a portable consumer device and wherein the directing step comprises:
directing the portable consumer device to mark the at least one other packet of the identified transmission for distinct routing.

9. The method of claim 1, wherein the transmission passes through an edge router onto the Internet and wherein the directing step comprises:
directing the edge router to mark the at least one other packet of the identified transmission for distinct routing.

10. The method of claim 1, wherein the transmission passes through at least one other router prior to passing through the at least one router and wherein the directing step comprises:
directing the at least one other router to mark the at least one other packet of the identified transmission for distinct routing.

11. The method of claim 1, wherein the instructing step comprises:
configuring the at least one router with priority queues so that the marked at least one other packet is distinctively treated.

12. A dynamic network provisioning system comprising:
at least one monitoring device that monitors data packets on a network; and
a controller coupled to the at least one monitoring device, the controller receiving the data packets from the monitoring device and configured to:
detect network congestion due to data on the network, the data passing through at least one router;
identify within the data a transmission from a source computer to a destination computer for distinct routing based on at least one packet of the transmission;
direct at least one other packet of the identified transmission to be marked for distinct routing; and
instruct the at least one router to distinctively route the at least one other marked packet in response to the detection of network congestion.

13. The system of claim 12, wherein the controller identifies the transmission within the data by:
identifying the transmission from the source computer to the destination computer for distinct routing in response to the detection of network congestion.

14. The system of claim 12, wherein the controller identifies the transmission within the data by:
identifying a streaming media transmission as the transmission.

15. The system of claim 12, wherein the controller is further configured to:
detect the absence of network congestion; and
cease the identification in response to the detected absence of network congestion.

16. The system of claim 12, wherein the controller detects the congestion by:
associating a bit rate threshold with one of the at least one router;
detecting a bit rate throughput at the one of the at least one router; and
detecting network congestion when the bit rate throughput exceeds the bit rate threshold.

17. The system of claim 12, wherein the controller is further configured to:
detect the absence of network congestion; and
direct the marking of the identified transmission to cease.

18. The system of claim 17:
wherein the controller detects the network congestion by:
associating an upper bit rate threshold with one of the at least one router;
detecting a bit rate throughput at the one of the at least one router; and
detecting network congestion when the bit rate throughput exceeds the bit rate threshold; and
wherein the controller detects the absence of network congestion by:
associating a lower bit rate threshold with one of the at least one router;
detecting the bit rate throughput at the one of the at least one router; and
detecting the absence of network congestion when the bit rate throughput is lower than the bit rate threshold.

19. The system of claim 12, wherein the transmission originates from a portable consumer device and wherein the controller directs marking by:
directing the portable consumer device to mark the at least one other packet of the identified transmission for distinct routing.

20. The system of claim 12, wherein the transmission passes through an edge router onto the Internet and wherein the controller directs marking by:
directing the edge router to mark the at least one other packet of the identified transmission for distinct routing.

21. The system of claim 12, wherein the transmission passes through at least one other router prior to passing through the at least one router and wherein the controller directs marking by:
directing the at least one other router to mark the at least one other packet of the identified transmission for distinct routing.

22. The system of claim 12, wherein the controller instructs the at least one router by:
configuring the at least one router with priority queues so that the marked at least one other packet is distinctively treated.
